(19) United States
(12) Patent Application Publication
(10) Pub. No.: US 2009/0138558 A1
(43) Pub. Date: May 28, 2009

(54) Automated Methods for the Handling of a Group Return Receipt for the Monitoring of a Group Delivery

(75) Inventors: Beth Benoit, Chelmsford, MA (US); Maureen G. Leland, Bolton, MA (US)

Correspondence Address: CANTOR COLBURN LLP - IBM LOTUS, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/945,532

(22) Filed: Nov. 27, 2007

(51) Int. Cl. G06F 15/16; G06Q 99/00

(52) U.S. Cl. 709/206; 705/1

(57) ABSTRACT

Exemplary embodiments of the present invention relate to a methodology for monitoring the delivery of mail pieces to a predetermined grouping of recipients and notifying the sender of the completion of the delivery tasks to the group of recipients.

### BACKGROUND OF THE INVENTION

1. Field of the Invention

This invention relates to return receipt mechanisms, and particularly to return receipt monitoring methodologies for electronic and physical messages.

2. Description of Background

Frequently, when delivering a set of mail pieces to a group of different recipients (i.e., mail pieces including electronic mail and physical mail, as in letters or packages) the need arises that the sender must know when all of the intended recipients have received their delivery. Thus, the delivery of the mail pieces is not complete until all of the objects have reached their destination.

### SUMMARY OF THE INVENTION

The shortcomings of the prior art are overcome and additional advantages are provided through the provision of a method for monitoring the delivery of mail pieces to an identified group of recipients. The method comprises identifying a group of mail pieces for delivery, wherein the mail piece group comprises at least two mail pieces and monitoring the delivery status of each mail piece comprised within the mail piece group for a delivery event, wherein monitoring the delivery status of a mail piece for a delivery event comprises configuring an identified mail piece to generate a return receipt upon the delivery of the mail piece in the event that the mail piece is an electronic mail message, monitoring for the return receipt that is generated by the electronic message upon the delivery of the electronic message, and associating a delivery tracking identifier with an identified mail piece in the event that the mail piece is a physical mail message or package, monitoring reported delivery tracking activity that is associated with the physical mail message or package delivery tracking identifier, and generating an electronic notification message in the event that all of the identified mail pieces have been delivered to their intended recipients.

Computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTION OF THE DRAWING

The subject matter that is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of a method for monitoring the delivery of mail pieces to a group of recipients in accordance with exemplary embodiments of the present invention.

The detailed description explains the preferred embodiments of the invention, together with advantages and features, by way of example with reference to the drawings.

### DETAILED DESCRIPTION OF THE INVENTION

One or more exemplary embodiments of the invention are described below in detail. The disclosed embodiments are intended to be illustrative only since numerous modifications and variations therein will be apparent to those of ordinary skill in the art.

Aspects of the exemplary embodiment of the present invention can be implemented within a conventional computing, system environment comprising hardware and software elements. Specifically, the methodologies of the present invention can be implemented as an add-on software message receipt confirmation monitoring component for a conventional email client application or accessed via a URL from a web page executing a dedicated web application in order to accomplish the prescribed tasks of the present invention as described below.

Exemplary embodiments of the present invention relate to a methodology for monitoring the delivery of mail pieces to a predetermined grouping of recipients and notifying the sender of the completion of the delivery tasks to the group of recipients. For example, consider that instance in which a manager may have an urgent need to schedule a meeting and in doing so must deliver transcripts before the meeting to the invitees. Therefore, the manager must ensure that before scheduling the meeting that each invitee has received the required transcript prior to attending the meeting.

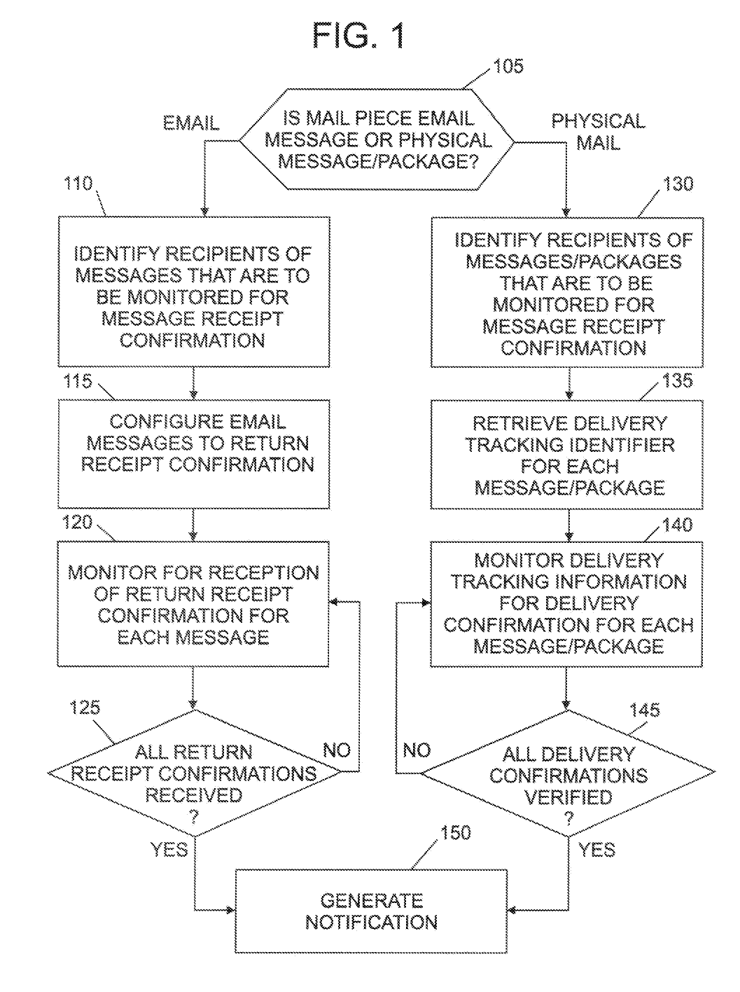

FIG. 1 shows a flow diagram illustrating an exemplary method for monitoring the delivery of mail pieces to a group of intended recipients. At step 105, the mail piece sender determines the type of message that will be delivered. Within exemplary aspects of the present invention a sender can monitor the delivery of an email message that is meant to be delivered to a specific group of recipients or a track the delivery of physical messages (i.e., letter) or packages that have been forwarded to a group of intended recipients.

In the event that a sender desires to forward and email message 106 to an intended group of individuals, at 110 the intended group of recipients is identified by the sender, wherein the recipients' email addresses are notated in the TO: header field of the email message (not shown). Further, a listing of the intended mail piece recipients is maintained by the message receipt confirmation monitoring component (not shown) that is operating in conjunction with the email client application. At step 115, the email message that is further configured to generate a return receipt upon the delivery and opening of the message by the intended recipient.

At step 120, the message receipt confirmation monitoring component monitors the incoming emails to the email client application for the reception of the return receipt confirmations generated by the delivery events initiated upon the delivery and opening of the email message by an intended recipient. As return receipts are delivered to the email client application, the message receipt confirmation monitoring component makes a notation of the delivery to its maintained recipient group list that the individual has received the email message. Upon receiving return receipts is from all intended message recipients indicating that the individuals have received their message delivery (step 125), the message receipt confirmation monitoring component generates 150 and displays a notification to the sender that the group mail piece delivery is complete.

In the event that a sender desires to forward a physical message or package 107 to an intended group of recipients the sender may access an instance of the message receipt confirmation monitoring component that is executed at a dedicated web page at a specific URL. Upon accessing the web page, the sender can identify the intended group of recipients (step 130) and associate each recipient with a delivery tracking identifier (step 135) that has been associated with each forwarded message/package. The delivery tracking identifier is obtained from the message/package delivery service that has been employed to deliver the messages/packages to the group of intended recipients.

At step 140, message receipt confirmation monitoring component will periodically contact the message/package delivery service delivery tracking system in order to retrieve the current delivery status information for each message/package that has been forwarded to an intended group recipient. As each message/package is delivered to a recipient the message receipt confirmation monitoring component annotates its maintained recipient group listing to reflect that message/package delivery status for each intended recipient. Upon determining that all of the forwarded messages/packages have reached their intended destinations (step 145) the message receipt confirmation monitoring component will generate and display a notification to the sender that the delivery for all the intended group recipients is complete. Within further exemplary aspects, the message receipt confirmation monitoring component also generates and transmits a delivery event completion notification email message to the sender in order to alert the sender of the completion of the delivery event monitoring task.

Within further exemplary embodiments of the present invention the message receipt confirmation monitoring component has the capability to provide interim delivery event updates on demand. For example, mail pieces are forwarded to a group of intended recipients. The message receipt confirmation monitoring component monitors the individual return receipts for each recipient against the list of recipients. When a return receipt is received from all recipients indicating they have received their delivery, the message receipt confirmation monitoring component presents a notification that the group delivery is complete. The message receipt confirmation monitoring component also gives interim updates on demand—via display at the email client application or the web page—reporting the percentage of recipients who have opened the email, thus providing interim delivery status (e.g., a message indicating that 80% of recipients have received the mail piece). The message receipt confirmation monitoring component could also provide an on demand list of the recipients and their individual delivery event status.

A further enhancement would be to tell the watcher to divide the recipients into categories (e.g., such as critical, important, optional, etc), wherein the message receipt confirmation monitoring component can report on what percentage of each category of recipients have received the mail (e.g., “100% of critical recipients have received; 75% of important recipients have received.” etc.). Within further exemplary embodiments this aspect of the present invention can be reported and displayed as a bar graph to the sender. The capabilities of the present invention can be implemented in software, firmware, hardware or some combination thereof.

As one example, one or more aspects of the present invention can be included in an article of manufacture (e.g., one or more computer program products) having, for instance, computer usable media. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagram depicted herein is just an example. There may be many variations to this diagram or the steps (or operations) described therein without departing from the spirit of the invention. For instance, the steps may be performed in a differing order, or steps may be added, deleted or modified. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for monitoring the delivery of mail pieces to an identified group of recipients, the method comprising:
identifying a group of mail pieces for delivery, wherein the mail piece group comprises at least two mail pieces;
monitoring the delivery status of each mail piece comprised within the mail piece group for a delivery event, wherein monitoring the delivery status of a mail piece for a delivery event comprises:
configuring an identified mail piece to generate a return receipt upon the delivery of the mail piece in the event that the mail piece is an electronic mail message;
monitoring for the return receipt that is generated by the electronic message upon the delivery of the electronic message; and
associating a delivery tracking identifier with an identified mail piece in the event that the mail piece is a physical mail message or package;
monitoring reported delivery tracking activity that is associated with the physical mail message or package delivery tracking identifier; and
generating an electronic notification message in the event that all of the identified mail pieces have been delivered to their intended recipients.

2. The method of claim 1, further comprising reporting a current delivery event status for each mail piece within a mail piece group.

3. A computer program product that includes a computer readable medium useable by a processor, the medium having stored thereon a sequence of instructions which, when executed by the processor, causes the processor to monitor the delivery of mail pieces to an identified group of recipients, by:
receiving information identifying a group of mail pieces for delivery, wherein the mail piece group comprises at least two mail pieces;
monitoring the delivery status of each mail piece comprised within the mail piece group for a delivery event, wherein monitoring the delivery status of a mail piece for a delivery event comprises:
configuring an identified mail piece to generate a return receipt upon the delivery of the mail piece in the event that the mail piece is an electronic mail message;
monitoring for the return receipt that is generated by the electronic message upon the delivery of the electronic message; and
associating a delivery tracking identifier with an identified mail piece in the event that the mail piece is a physical mail message or package;
monitoring reported delivery tracking activity that is associated with the physical mail message or package delivery tracking identifier; and
generating an electronic notification message in the event that all of the identified mail pieces have been delivered to their intended recipients.

4. The computer program product of claim 3, further comprising reporting a current delivery event status for each mail piece within a mail piece group.
